(19) United States
(12) Patent Application Publication
(10) Pub. No.: US 2017/0331291 A1
(43) Pub. Date: Nov. 16, 2017

(54) POWER ADJUSTMENT DEVICE, POWER DISTRIBUTION SYSTEM, POWER ADJUSTMENT METHOD, AND NON-TRANSITORY COMPUTER-READABLE MEDIUM IN WHICH PROGRAM IS STORED

(71) Applicant: NEC Corporation, Tokyo (JP)

(72) Inventor: Kiyohisa ICHINO, Tokyo (JP)

(73) Assignee: NEC Corporation, Tokyo (JP)

(21) Appl. No.: 15/528,932

(22) PCT Filed: Aug. 31, 2015
(86) PCT No.: PCT/JP2015/004393

§ 371 Date: May 23, 2017

(30) Foreign Application Priority Data
Nov. 27, 2014 (JP) 2014-240038

(51) Int. Cl. H02J 3/32; H02J 7/00

(52) U.S. Cl. CPC H02J 3/32; H02J 7/0068

(57) ABSTRACT

Provided is a power adjustment device capable of adjusting the supply and demand of electric power with appropriate timing using a power storage device. The power adjustment device (10) has a difference estimation unit (12), a charging/discharging power amount calculation unit (14), and an instruction unit (16). The difference estimation unit (12) estimates a first difference between a power generation amount and a power consumption amount during a predetermined first period in intervals of time shorter than the first period. The charging/discharging power amount calculation unit (14) calculates a charging/discharging power amount, which is an amount of electric power to be charged to or discharged from a power storage device (20), on the basis of the estimated first difference and the remaining time to the end of the first period. The instruction unit (16) instructs the power storage device (20) to charge or discharge a power amount that corresponds to the calculated charging/discharging power amount.

### TECHNICAL FIELD

The present invention relates to a power adjustment device, a power distribution system, a power adjustment method, and a program, and more particularly, to a power adjustment device, a power distribution system, a power adjustment method, and a program for adjusting supply (generation) and demand (consumption) of power.

### BACKGROUND ART

With recent deregulation of electric power, power has been supplied to a power customer (power consumer) by a power producer and supplier (PPS) called new power, which is different from a general power supplier which is a major power company. The power producer and supplier does not possess a power network (power transmission/distribution grid) in many cases. Therefore, the power producer and supplier rents a power network owned by a general power supplier, and supplies power (retails power) to the power customer via the power network.

In Japan, the full deregulation of electric power is scheduled in 2016 and thus an increase in the number of power producers and suppliers for retailing power is expected. A wheeling clause for a general power supplier requires balancing between power generation and consumption in a predetermined period in many cases. The balancing between power generation and consumption in a predetermined period (a control period: for example, 30 minutes) is generally called balancing. Under the existing system, the PPS is required to observe 30-minute balancing rule. The 30-minute balancing rule described herein indicates that an electric power generation is matched with an electric power demand for 30 minutes. Under the 30-minute balancing rule, there is no need to instantaneously match the generated power with the demand power. Supply and demand of power are adjusted so as to match cumulative values (i.e., electric energy) of the generated power and the demand power for 30 minutes.

When there is a difference between the electric power generation and the electric power demand in the control period, a system operator (general power supplier) makes up the difference. However, in return for this, the PPS pays a charge corresponding to the difference between the electric power generation and the electric power demand to the system operator. In this case, the difference between the electric power generation (generated energy) and the electric power demand (consumed energy) is referred to as an imbalance, and a penalty incurred depending on the imbalance is referred to as an imbalance charge. As the imbalance charge, two types of charges, that are a fluctuation-range power generation charge and an outside-fluctuation-range power generation charge, are set. When the imbalance is equal to or less than electric energy corresponding to a value of half of 3% of a contract demand (corresponding to the electric energy when power of 3% of the contract demand is continued for 30 minutes), the PPS pays the fluctuation-range power generation charge. Further, when the imbalance exceeds the electric energy corresponding to a value of half of 3% of the contract demand, the PPS also pays the outside-fluctuation-range power generation charge for excess electric energy. In this case, “the electric energy corresponding to a value of half of 3% of the contract demand” is represented by P*0.03/2 [Wh], when the contract demand=P[W].

In general, the outside-fluctuation-range power generation charge in the case of power shortage (i.e., when the consumed energy exceeds the generated energy) is punitively set to a high value. Further, when a power surplus is generated and the imbalance exceeds the electric energy corresponding to a value of half of 3% of the contract demand, excess electric energy is brought back to the general power supplier without any charge. Therefore, it is important for management of the PPS to suppress the imbalance. To suppress the imbalance, it is required to predict a generated energy and a demand energy. However, in many cases, it is difficult to eliminate prediction errors. Prediction errors become the imbalance which is a burden to the PPS.

In association with such a technique, PTL 1 discloses a power wheeling support device for supporting wheeling of electric power to reliably carry out balancing control. In PTL 1, in a power supply/demand system, when supply electric energy to a power system by electric energy in a specified time (for example, 30 minutes) is set to be equal to received electric energy from a power system by a power customer, a supply/demand adjustment support means first compares the supply electric energy from the power supplier that is detected by a supply power detection means, with the received electric energy by the power customer that is detected by a received power detection means. For example, the supply power detection means and the received power detection means detect, at a predetermined timing in a specified time, tentative supply electric energy and tentative received electric energy by a power supplier and a power customer, respectively, until a predetermined timing in the specified time. The supply/demand adjustment support means determines, based on the tentative supply electric energy and the tentative received electric energy until the predetermined timing in the specified time, whether the tentative supply electric energy is larger than the tentative received electric energy, whether the tentative received electric energy is larger than the tentative supply electric energy, or whether the tentative received electric energy and the tentative supply electric energy are equal.

When the tentative supply electric energy is larger than the tentative received electric energy, the received electric energy by the power customer is adjusted to increase relatively to the supply electric energy by the power supplier during a remaining time to expiration of the specified time. When the tentative received electric energy is larger than the tentative supply electric energy, the supply electric energy by the power supplier is adjusted to increase relatively to the received electric energy by the power customer during a remaining time to expiration of the specified time.

In PTL 1, control is performed in such a manner that the received electric energy by the power customer or the supply electric energy by the power supplier is changed depending on the difference between the tentative received electric energy and the tentative supply electric energy. In this control, it is necessary to change the received electric energy or the supply electric energy from actually required electric energy. When power generation equipment or a load in which it is difficult to control the electric energy to be increased or decreased is used, it is actually difficult to implement the control.

At present, distributed secondary batteries, such as a battery for an electric vehicle and a home storage battery, are in widespread use. Accordingly, it can be considered to reduce the imbalance using these secondary batteries. Specifically, control is performed in such a manner that, when an excess supply (the generated energy>the demand electric energy) is expected, the demand electric energy is increased by charging a secondary battery, and when a supply shortage (the generated energy<the demand electric energy) is expected, power is discharged from the secondary battery to increase the generated energy. A technique for performing such control is disclosed in PTL 2.

PTL 2 discloses a power feed method with which a power producer and supplier can easily feed balancing power in accordance with electric energy consumed by a load of a customer. The power feed method disclosed in PTL 2 includes: preparing a secondary battery; calculating a difference between power supplied from one or more power generation facilities and consumed power of one or more specific loads; feeding power to the load or a power grid through a DC-AC conversion device from the secondary battery, or charging the secondary battery through an AC-DC conversion device from the power generation facility or the power grid, so as to eliminate the calculated difference; and supplying power to be consumed by the load from the power generation facility in a balancing manner.

Specifically, in PTL 2, a control device measures the generated energy and the consumed power of a load of a customer (demander) at a predetermined interval. The control device calculates (generated energy−consumed power) when the time is in a predetermined period t0 (for example, 20 minutes) from the start of 30 minutes set as a unit period so as to achieve balancing power control. When the absolute value is greater than a set value, a result of the calculation (generated energy−consumed power) is stored and an amount of charge/discharge of the secondary battery is calculated. Based on the amount of charge/discharge, the secondary battery is controlled to satisfy: generated energy−consumed power=0.

On the other hand, when the time is not in the predetermined period t0 from the start of 30 minutes set as a unit period so as to achieve balancing power control, the control device calculates a sum A of (generated energy−consumed power) in the predetermined period t0 from the start of 30 minutes set as a unit period. Further, the control device calculates an amount of charge/discharge of the secondary battery in the predetermined period t0 from the start of 30 minutes set as a unit period, and adds the amount of charge/discharge to the sum A. Next, the control device determines a charge/discharge amount B of the secondary battery in a period after the predetermined period t0 of 30 minutes set as a unit period, based on the added sum A. The control device calculates (generated energy−consumed power) at the present time, adds the charge/discharge amount B thereto to obtain a charge/discharge amount C, and controls the secondary battery to be charged/discharged based on the charge/discharge amount C.

### CITATION LIST

### Patent Literature

[PTL 1]Japanese Unexamined Patent Application Publication No. 2013-118725

[PTL 2]Japanese Unexamined Patent Application Publication No. 2003-250221

### SUMMARY OF INVENTION

### Technical Problem

In PTL 2, there is a possibility that the secondary battery intensively performs charging/discharging toward the end of the period of 30 minutes in which balancing is to be satisfied. This behavior will be described. When the acquired difference between the generated energy and the demand electric energy is continuously equal to or less than a predetermined threshold in a period t0 at the start of 30 minutes, the secondary battery does not perform charging/discharging. In this case, after a lapse of the period t0 at the start of 30 minutes, the secondary battery collectively performs charging/discharging depending on a sum of differences between the generated energy and the demand electric energy, acquired within the period t0 at the start of 30 minutes. That is, in PTL 2, there is a possibility that the secondary battery may be intensively charged/discharged in the last period (0.5−t0) of 30 minutes.

When the secondary battery is charged/discharged in such a short period of time, the charge/discharge power may exceed a rated output of the secondary battery or an inverter. Further, such a rapid fluctuation in load may cause a disturbance in a system, which may degrade power quality. It is also possible to employ a method of lowering the predetermined threshold in PTL 2 so as to prevent the secondary battery from being intensively charged/discharged at the end of 30 minutes. However, when the threshold is lowered, a frequency of charge/discharge of the secondary battery increases, which causes another problem that the secondary battery is more likely to deteriorate. Therefore, there is a demand for adjusting supply and demand of power at an appropriate timing by using a power storage device such as a secondary battery.

The present invention has been made to solve the above-mentioned problems, and an object of the present invention is to provide a power adjustment device, a power distribution system, a power adjustment method, and a program which are capable of adjusting supply and demand of power at an appropriate timing using a power storage device.

### Solution to Problem

A power adjustment device according to the present invention includes difference estimation means that estimates a first difference between a generated energy and a consumed energy in the first period for each time interval shorter than a predetermined first period, charging/discharging energy calculation means that calculates a charging/discharging energy based on the estimated first difference and a remaining time to an end of the first period, the charging/discharging energy being electric energy to be charged or discharged in a power storage device, and instruction means that instructs the power storage device to charge or discharge electric energy that corresponds to the calculated charging/discharging energy.

A power distribution system according to the present invention includes a power generation equipment, a load, a power adjustment device, and a power storage device, in which the power adjustment device includes, difference estimation means that estimates a first difference between a generated energy generated by the power generation equipment and a consumed energy consumed by the load and the power storage device in a predetermined first period for each time interval shorter than the first period, charging/discharging energy calculation means that calculates a charging/discharging energy based on the estimated first difference and a remaining time to an end of the first period, the charging/discharging energy being electric energy to be charged or discharged in the power storage device, and instruction means that instructs the power storage device to charge or discharge electric energy that corresponds to the calculated charging/discharging energy.

A power adjustment method according to the present invention includes estimating a first difference between a generated energy and a consumed energy in a predetermined first period for each time interval shorter than the first period, calculating a charging/discharging energy, based on the estimated first difference and a remaining time to an end of the first period, the charging/discharging energy being electric energy to be charged or discharged in a power storage device, and instructing the power storage device to charge or discharge electric energy that corresponds to the calculated charging/discharging energy.

A program according to the present invention causes a computer to implement a function for estimating a first difference between a generated energy and a consumed energy in a predetermined first period for each time interval shorter than the first period, a function for calculating a charging/discharging energy as electric energy to be charged or discharged in a power storage device based on the estimated first difference and a remaining time to an end of the first period, and a function for instructing the power storage device to charge or discharge electric energy that corresponds to the calculated charging/discharging energy.

### Advantageous Effects of Invention

According to the present invention, it is possible to provide a power adjustment device, a power distribution system, a power adjustment method, and a program which are capable of adjusting supply and demand of power at an appropriate timing by using a power storage device.

### BRIEF DESCRIPTION OF DRAWINGS

FIG. 1 is a diagram illustrating an outline of a power distribution system according to an example embodiment of the present invention;

FIG. 2 is a diagram illustrating a power distribution system according to a first example embodiment;

FIG. 3 is a diagram illustrating a configuration of a power adjustment device according to the first example embodiment;

FIG. 4 is a flowchart illustrating an operation of the power adjustment device according to the first example embodiment; and

FIG. 5 is a diagram for explaining a time slot according to the first example embodiment.

### EXAMPLE EMBODIMENTS

### (Outline of Example Embodiments According to the Present Invention)

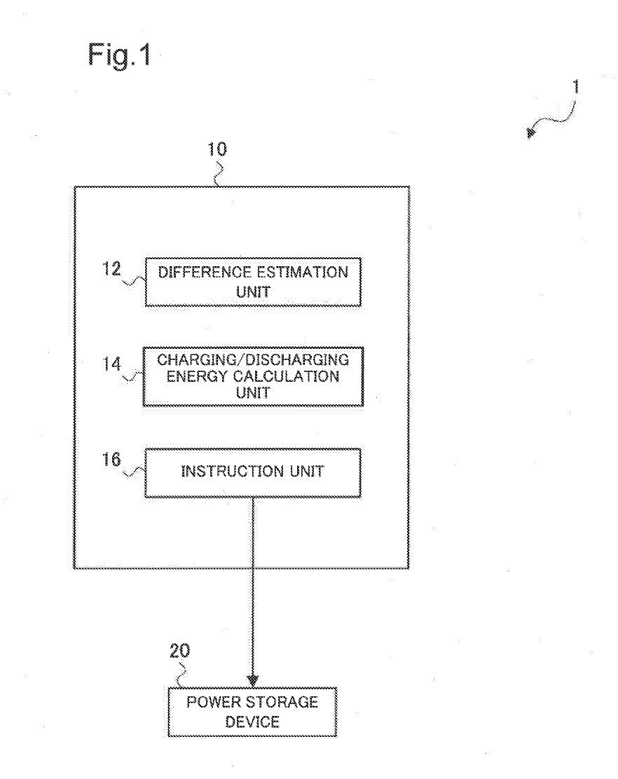

Prior to giving a description of example embodiments, an outline of example embodiments according to the present invention will be described with reference to FIG. 1. FIG. 1 is a diagram illustrating an outline of a power distribution system 1 according to an example embodiment of the present invention. The power distribution system 1 includes a power adjustment device 10 and a power storage device 20. The power adjustment device 10 includes a difference estimation unit 12 having a function as a difference estimation means; a charging/discharging energy calculation unit 14 having a function as a charging/discharging energy calculation means; and an instruction unit 16 having a function as an instruction means.

The difference estimation unit 12 estimates a first difference between a generated energy and a consumed energy in a predetermined first period for each time interval shorter than the first period. The charging/discharging energy calculation unit 14 calculates a charging/discharging energy, which is electric energy to be charged or discharged in the power storage device 20, based on the estimated first difference and a remaining time to an end of the first period. The instruction unit 16 instructs the power storage device 20 to charge or discharge energy that corresponds to the calculated charging/discharging energy.

In the power distribution system 1 according to the example embodiment of the present invention, the power storage device 20 is prevented from intensively charging or discharging power only for a certain time interval in a control period (e.g., at the end of the control period). Therefore, the power distribution system 1 according to the example embodiment of the present invention can adjust supply and demand of power at an appropriate timing by using the power storage device 20. Note that the power adjustment device 10 and a power adjustment method and program to be executed by the power adjustment device 10 can also adjust supply and demand of power at an appropriate timing by using the power storage device 20.

### First Example Embodiment

A first example embodiment will be described below with reference to the drawings. Note that the same elements are denoted by the same reference numerals in the drawings, and repeated descriptions thereof are omitted as appropriate to clarify the explanation.

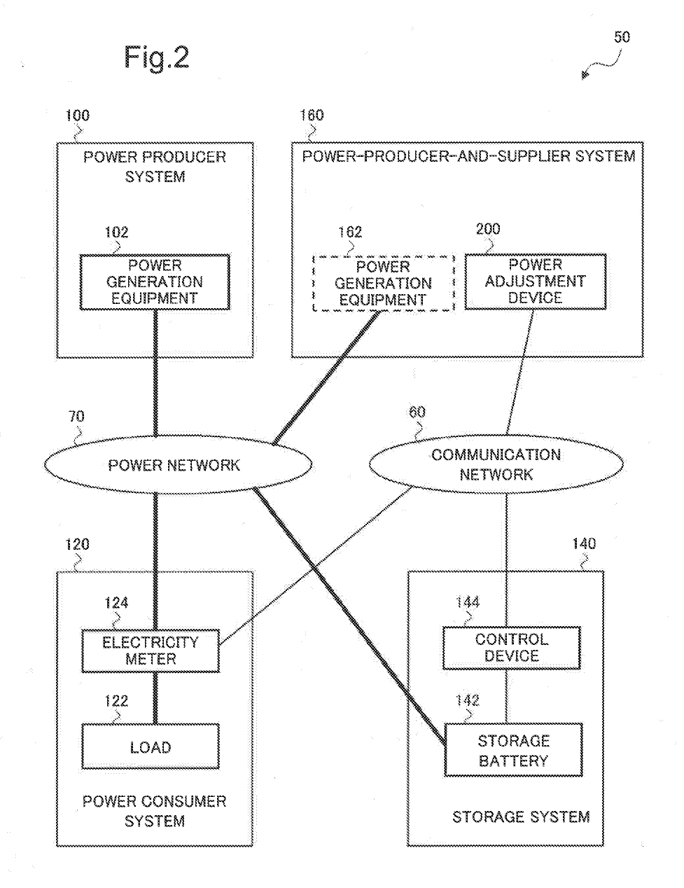

FIG. 2 is a diagram illustrating a power distribution system 50 according to the first example embodiment. The power distribution system 50 includes a power producer system 100, a power consumer system 120, a storage system 140, and a power-producer-and-supplier system 160. The power consumer system 120, the storage system 140, and the power-producer-and-supplier system 160 are connected to each other in such a manner that they can communicate with each other via a communication network 60 such as the Internet, for example. The power producer system 100, the power consumer system 120, and the storage system 140 are connected to each other in such a manner that they can transmit or receive power via a power network 70. Note that transformation installation is omitted in FIG. 2.

In this case, the power network 70 is, for example, a system in which facilities for supplying power to a power receiving facility owned by a demander from a power generation facility owned by a power producer, such as a commercial power, a power system, and a power transmission/distribution grid, are integrated. Note that the above-mentioned communication network 60 may be a part of the power network 70. In other words, the communication network 60 may be configured to perform communication via the power network 70.

The power producer system 100 is, for example, a system owned by a general power supplier. The power producer system 100 includes at least one power generation equipment 102. The power generation equipment 102 is a device (power supply) that performs power generation to generate electric power. The power generation equipment 102 is, for example, a thermal power generation facility, a photovoltaic power generation device, a wind-power generation device, a geothermal power generation facility, or the like. However, the power generation equipment is not limited to these examples. Note that the power generation equipment 102 is not limited to one physical device, but instead may be an aggregation of a plurality of power generation facilities. The power producer system 100 transmits power (power transmission) generated by the power generation equipment 102 to the power network 70.

The power consumer system 120 is a system owned by power consumer (demander). The power consumer system 120 includes at least one load 122 and an electricity meter 124. The load 122 consumes power supplied (received) from the power network 70. For example, when the power consumer is a general household, the load 122 is home electrical equipment. However, the load is not limited to this. The electricity meter 124 measures the consumed energy of the load 122. The electricity meter 124 transmits the measured consumed energy to a power adjustment device 200 via the communication network 60.

The storage system 140 includes a storage battery 142 serving as a power storage device, and a control device 144. The storage battery 142 is, for example, a secondary battery. Further, the storage system 140 may include a bidirectional inverter (not illustrated) for converting a direct current and an alternating current to each other and interconnecting the storage battery 142 to a system.

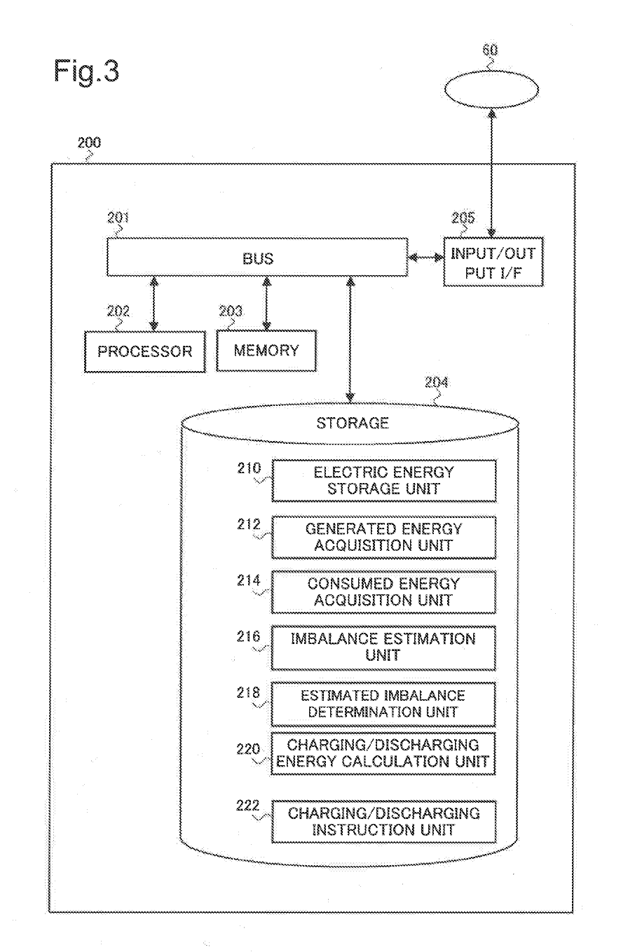

The control device 144 is, for example, a computer. The control device 144 may have a hardware configuration similar to that of the power adjustment device 200 as described later with reference to FIG. 3. As described later, the control device 144 receives, from the power-producer-and-supplier system 160 (power adjustment device 200), an instruction (charging/discharging instruction) for causing the storage battery 142 to perform charging/discharging. Further, the control device 144 controls the storage battery 142 to perform charging or discharging in response to the charging/discharging instruction. The storage battery 142 is charged with power supplied from the power network 70 in accordance with the control of the control device 144, and stores the charged power. Further, the storage battery 142 discharges the stored power to the power network 70 in accordance with the control of the control device 144.

The power-producer-and-supplier system 160 is a system including a power producer and supplier (PPS or a new power supplier). The power-producer-and-supplier system 160 may include the power generation equipment 102. Further, when the power-producer-and-supplier system 160 does not include, for example, the power generation equipment 102, the power-producer-and-supplier system 160 performs control for obtaining power to be supplied to the power consumer from another power supplier (the power producer system 100 etc.).

Further, the power-producer-and-supplier system 160 includes the power adjustment device 200. The power adjustment device 200 sends the charging/discharging instruction to the storage system 140 so that a generated energy (power generation) and a consumed energy (demand) in a control period (first period), which is a period in which demand and supply of power are adjusted (i.e., a period in which balancing should be satisfied), are set to values as close as possible. Details thereof will be described later.

Note that the example embodiment illustrates a case where the period in which a balancing control is performed, i.e., the control period, is 30 minutes. However, the control period is not limited to 30 minutes. Further, in the following example embodiments, the term “balancing” is used. However, demand and supply of power need not necessarily set to be “equal” in “the same period”. The “balancing” does not mean that a difference between supply and demand of power in a certain period is not allowed at all, and the “balancing” means that, if there is a difference therebetween, the difference is minimized. Further, the control period need not necessarily be constant. The control period may be 30 minutes in a certain period of time, and may be one hour in another period of time.

FIG. 3 is a diagram illustrating the configuration of the power adjustment device 200 according to the first example embodiment. The power adjustment device 200 includes a bus 201, a processor 202, a memory 203, a storage 204, and an input/output interface 205. The power adjustment device 200 has a function as a computer for executing a program with this configuration.

The bus 201 has a function as a data transmission line through which the processor 202, the memory 203, the storage 204, and the input/output interface 205 transmit and receive data to and from one another. The processor 202 is an arithmetic processing unit such as a CPU (Central Processing Unit) or a GPU (Graphics Processing Unit). The memory 203 is a storage device such as a RAM (Random Access Memory) or a ROM (Read Only Memory). The storage 204 is a storage device such as a hard disk, an SSD (Solid State Drive), or a memory card. The storage 204 may be a memory such as a RAM or a ROM.

The storage 204 stores programs such as various modules respectively corresponding to electric energy storage unit 210, a generated energy acquisition unit 212, a consumed energy acquisition unit 214, an imbalance estimation unit 216, an estimated imbalance determination unit 218, a charging/discharging energy calculation unit 220, a charging/discharging instruction unit 222, and the like. The processor 202 executes the modules stored in the storage 204, thereby implementing the respective functions of the electric energy storage unit 210, the generated energy acquisition unit 212, the consumed energy acquisition unit 214, the imbalance estimation unit 216, the estimated imbalance determination unit 218, the charging/discharging energy calculation unit 220, and the charging/discharging instruction unit 222. Note that the functions of these components will be described later.

In this case, the electric energy storage unit 210 stores the generated energy (planned value) acquired by the generated energy acquisition unit 212. Further, the electric energy storage unit 210 stores the accumulated value (cumulative total) of the consumed energy of the load 122 that are acquired and accumulated by the consumed energy acquisition unit 214. Furthermore, the electric energy storage unit 210 stores the accumulated value (cumulative total) of the charging/discharging energy that is calculated by the charging/discharging energy calculation unit 220 and instructed by the charging/discharging instruction unit 222. Detailed thereof will be described later.

The input/output interface 205 is an interface (I/F) for the power adjustment device 200 to transmit data to an external device, or receive data therefrom. Specifically, the input/output interface 205 is an interface for transmitting or receiving information via the communication network 60. Further, the input/output interface 205 may be an interface for acquiring information from an input device such as a keyboard, or may be an interface for acquiring information from an external device such as a storage. The input/output interface 205 is used for the power adjustment device 200 to transmit information to the power consumer system 120 or the storage system 140, or receive information therefrom.

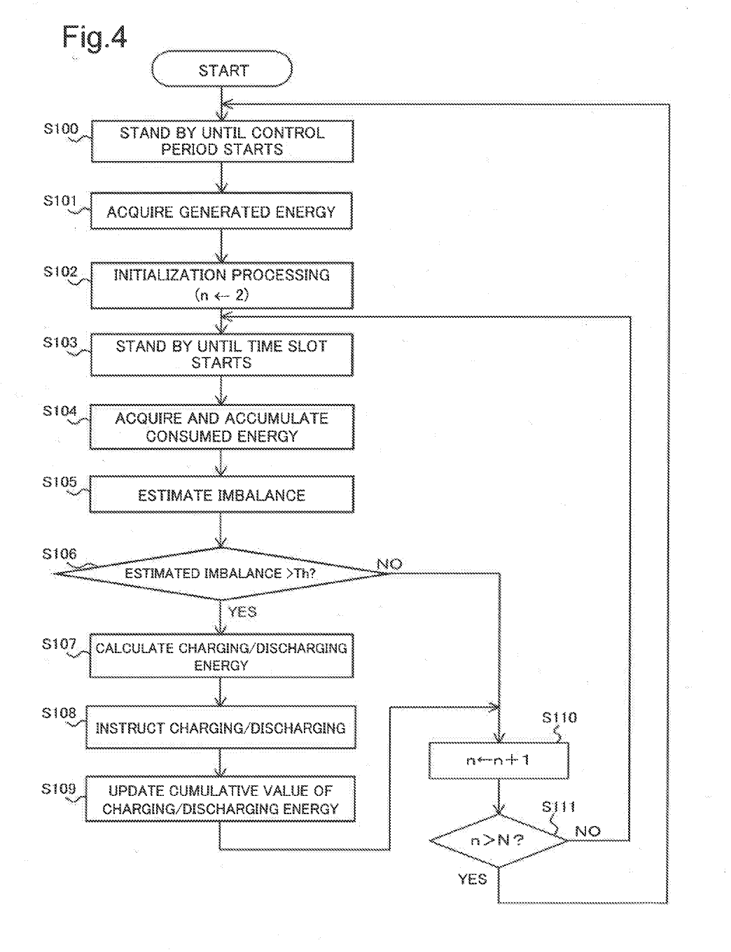

FIG. 4 is a flowchart illustrating an operation of the power adjustment device 200 according to the first example embodiment. First, the power adjustment device 200 stands by until the control period starts (step S100). As mentioned above, the control period herein refers to a period in which balancing should be satisfied. For example, when the length of the control period is 30 minutes, the power adjustment device 200 stands by until the current time reaches 00:00, 00:30, 01:00, etc. Note that “00:00” indicates 12:00 a.m., and “00:30” indicates 12:30 a.m.

Next, the power adjustment device 200 acquires the generated energy of the power generation equipment 102 in a current control period (S101). Specifically, the generated energy acquisition unit 212 of the power adjustment device 200 acquires a planned value of the electric energy estimated to be generated by the power generation equipment 102 in the current control period. Further, the generated energy acquisition unit 212 stores the acquired planned value of the generated energy in the electric energy storage unit 210. In general, the power producer and supplier makes a power generation plan in advance in consideration of estimation of demand (consumed energy), the previous actual values, weather, and the like. Therefore, the generated energy acquisition unit 212 may acquire the planned value of the generated energy from the power generation plan.

Next, the power adjustment device 200 performs initialization processing of variables (step S102). Specifically, the power adjustment device 200 initializes, to 0, each of the accumulated value of the consumed energy of the load and the accumulated value of the charging/discharging energy that are stored in the electric energy storage unit 210. Further, the power adjustment device 200 initializes the number n of the time slot to be processed to 2. The “time slot” will be described below.

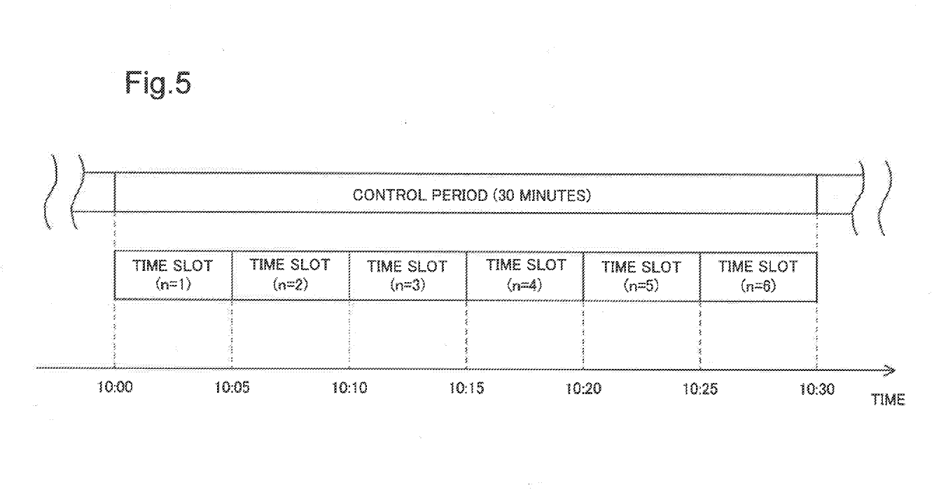

FIG. 5 is a diagram for describing the time slot according to the first example embodiment. The time slot is a period of a time interval shorter than the control period. For example, when the control period is 30 minutes, the length of the time slot may be set to five minutes. In this case, one control period includes six time slots. Note that the number of time slots included in one control period is represented by N. In the above example, N=6 holds.

The time slots are numbered in an ascending order of time. For example, when the current control period is a period from 10:00 to 10:30, the first (n=1) time slot corresponds to a period from 10:00 to 10:05. Similarly, the second (n=2) time slot corresponds to a period from 10:05 to 10:10.

The power adjustment device 200 stands by until the n-th time slot starts (step S103). For example, when S103 is processed subsequent to S102, n=2 holds, and thus the power adjustment device 200 stands by until 10:05 when a second time slot starts. Further, when S103 is processed subsequent to S110 and n=3 holds, the power adjustment device 200 stands by until 10:10 when a third time slot starts.

Next, the power adjustment device 200 acquires a consumed energy, and accumulates the acquired consumed energy (step S104). Specifically, the consumed energy acquisition unit 214 of the power adjustment device 200 acquires, from the electricity meter 124 of the power consumer system 120, the measured value of the consumed energy of the load 122 in the (n−1)-th time slot. Further, the consumed energy acquisition unit 214 adds the acquired measured value of the consumed energy to the cumulative total of the consumed energy of the load 122.

For example, in the example of FIG. 5, when the number n of the time slot is 2, the consumed energy acquisition unit 214 acquires the electric energy (consumed energy) consumed by the load 122 in a period (10:00 to 10:05) that corresponds to a first time slot, and accumulates the acquired electric energy. Further, in the example of FIG. 5, for example, when the number n of the time slot is 3, the consumed energy acquisition unit 214 acquires the electric energy (consumed energy) consumed by the load 122 in a period (10:05 to 10:10) that corresponds to the second time slot, and accumulates the acquired electric energy. At this time, the electric energy storage unit 210 preliminarily stores the consumed energy of the load 122 in the period (10:00 to 10:05) corresponding to the first time slot. Therefore, the electric energy storage unit 210 stores the sum of the consumed energy of the load 122 in the period corresponding to the first time slot and the consumed energy of the load 122 in the period corresponding to the second time slot.

Next, the power adjustment device 200 estimates the imbalance (step S105). Specifically, the imbalance estimation unit 216 of the power adjustment device 200 estimates the imbalance (first difference) [Wh]corresponding to the difference between the generated energy and the consumed energy in the current control period. More specifically, for example, the imbalance estimation unit 216 calculates the estimated imbalance (estimated imbalance) by the following Expression (1).

{estimated imbalance}={planned value of generated energy}−{cumulative total of charging/discharging energy}−{(cumulative total of consumed energy of load)×N/(n−1)} Expression (1)

In this expression, {planned value of generated energy} represents a value indicating the generated energy in the current control period (30 minutes) acquired in the process of S101. Further, {cumulative total of charging/discharging energy} represents the accumulated value of the charging/discharging energy that is updated in S109 as described later and stored in the electric energy storage unit 210. Note that the charging/discharging energy is a positive value in the case of charging, and is a negative value in the case of discharging. Further, the “cumulative total of consumed energy of the load” is the cumulative value of the consumed energy for the (n−1)-th time slots that is updated in S104 and is stored in the electric energy storage unit 210. As mentioned above, N represents the number of time slots (N=6 in the example of FIG. 5).

The estimated imbalance is a positive value when an excess supply is estimated, and the estimated imbalance is a negative value when a supply shortage is estimated. Note that in Expression (1), {(cumulative total of consumed energy of load)×N/(n−1)} indicates a predicted value of the consumed energy (load consumed energy) of the load 122 in the current control period. Further, {(cumulative total of consumed energy of load)×N/(n−1)} in Expression (1) indicates a predicted value of the consumed energy in the current control period, assuming that the previous average power consumption of the load 122 is equal to the future average power consumption thereof. Specifically, the estimated imbalance is a value obtained by estimating, at the present time, the imbalance when the control period of 30 minutes has expired. For example, in the example of FIG. 5, when n=3, the predicted value of the consumed energy of the load 122 in the current control period is calculated assuming that an average value of the consumed energy in a period from 10:00 to 10:10 (from the first time slot to the second time slot) is equal to an average value of the consumed energy in a period from 10:10 to 10:30 (from the third time slot to a sixth time slot). It can be said that when the storage battery 142 has performed charging, the storage battery 142 has consumed power. Therefore, the “consumed energy” in the power distribution system 50 is a total value of the electric energy consumed by the load 122 and the electric energy charged in the storage battery 142 (in the case of discharging, a negative value). That is, {cumulative total of charging/discharging energy}+{(cumulative total of consumed energy of load)×N/(n−1)} indicates the estimated value of the “consumed energy” in the power distribution system 50.

Next, the power adjustment device 200 determines whether the absolute value of the estimated imbalance exceeds a predetermined threshold Th (step S106). Specifically, the estimated imbalance determination unit 218 of the power adjustment device 200 compares the threshold Th with the absolute value of the estimated imbalance calculated by the imbalance estimation unit 216 in S105. Further, the estimated imbalance determination unit 218 determines whether the absolute value of the estimated imbalance is greater than the threshold Th. In this case, the threshold Th is determined so as to reduce payment of, for example, an outside-fluctuation-range power generation charge. For example, the threshold Th may be set to a value [Wh]equal to or less than half of 3% of a contract demand. For example, the threshold Th may be set to a value [Wh]equal to or less than 3% of the planned value of the generated energy acquired in S101. When the absolute value of the estimated imbalance exceeds the threshold Th, the process proceeds to S107, and when the absolute value does not exceed the threshold, the process proceeds to S110.

When the absolute value of the estimated imbalance exceeds the threshold Th (YES in S106), the power adjustment device 200 calculates the charging/discharging energy of the storage battery 142 (step S107). Specifically, the charging/discharging energy calculation unit 220 of the power adjustment device 200 calculates the charging/discharging energy to be charged or discharged in the storage battery 142 in the n-th time slot. More specifically, the charging/discharging energy calculation unit 220 calculates the charging/discharging energy by the following Expression (2).

{charging/discharging energy}={estimated imbalance}/(N−n+1) Expression (2)

In Expression (2), {estimated imbalance} represents the estimated imbalance calculated by the imbalance estimation unit 216 in S105. Further, (N−n+1) represents the number of remaining time slots in the current control period. In other words, (N−n+1) represents a remaining time to an end of the current control period.

For example, in the example of FIG. 5, the charging/discharging energy when n=2 is represented by {estimated imbalance when n=2}/5. Further, the charging/discharging energy when n=3 is represented by {estimated imbalance when n=3}/4. Further, the charging/discharging energy when n=6 is represented by {estimated imbalance when n=6}/1.

As the number n increases (as time elapses), the proportion of the charging/discharging energy in the estimated imbalance increases. Accordingly, it seems that the absolute value of the charging/discharging energy increases toward the end of the control period. Thus, it also seems that the storage battery 142 intensively performs charging/discharging at the end of the control period. However, as described later, basically, the absolute value of the estimated imbalance gradually decreases as the number n increases (i.e., as time elapses). Therefore, in the example embodiment, it is less likely that the absolute value of the charging/discharging energy increases toward the end of the control period. For example, when the power consumption of the load is constant, the consumed energy of the load 122 in each time slot is constant. Therefore, {(cumulative total of consumed energy of load)×N/(n−1)} in Expression (1) is constant. Thus, the charging/discharging energy calculated by Expression (2) is constant regardless of the value n.

Note that when the charging/discharging energy indicates a positive value (i.e., when an excess supply is estimated), the charging/discharging energy corresponds to the electric energy to be charged in the storage battery 142 in the n-th time slot. On the other hand, when the charging/discharging energy indicates a negative value (i.e., a supply shortage is estimated), the charging/discharging energy corresponds to the electric energy to be discharged in the storage battery 142 in the n-th time slot.

Next, the power adjustment device 200 performs the charging/discharging instruction to the storage system 140 (step S108). Specifically, the charging/discharging instruction unit 222 of the power adjustment device 200 generates the charging/discharging instruction indicating the charging/discharging energy calculated by the charging/discharging energy calculation unit 220 in S107. Further, the charging/discharging instruction unit 222 transmits the charging/discharging instruction to the control device 144 of the storage system 140 via the communication network 60.

When the sign of the charging/discharging energy calculated in S107 is positive, the charging/discharging instruction unit 222 instructs the storage battery 142 to charge the electric energy corresponding to the charging/discharging energy in an n-th time slot. On the other hand, when the sign of the charging/discharging energy calculated in S107 is negative, the charging/discharging instruction unit 222 instructs the storage battery 142 to discharge the electric energy corresponding to the charging/discharging energy in the n-th time slot.

Upon receiving the charging/discharging instruction from the power adjustment device 200, the control device 144 of the storage system 140 controls the storage battery 142 to perform charging or discharging in response to the received charging/discharging instruction. Thus, in the case of an excess supply, the storage battery 142 is charged with the electric energy corresponding to the estimated imbalance in the n-th time slot. On the other hand, in the case of a supply shortage, the storage battery 142 discharges the electric energy according to the estimated imbalance in the n-th time slot.

The power adjustment device 200 updates the cumulative total of the charging/discharging energy (step S109). Specifically, the electric energy storage unit 210 of the power adjustment device 200 adds the charging/discharging energy calculated in S107 to the accumulated value of the charging/discharging energy stored prior to the processing in the n-th time slot. Thus, the cumulative total of the charging/discharging energy stored in the electric energy storage unit 210 is updated.

Note that when n=2, the process of S107 is not performed in the first time slot, and the cumulative value of the charging/discharging energy preliminarily stored in the electric energy storage unit 210 is 0 [Wh]. Therefore, when n=2, in S109, the electric energy storage unit 210 stores the charging/discharging energy [Wh]calculated in the time slot when n=2 as the updated cumulative total of the charging/discharging energy. Further, when n=3, the cumulative value of the charging/discharging energy preliminarily stored in the electric energy storage unit 210 is the charging/discharging energy [Wh]calculated in the time slot when n=2. Therefore, when n=3, in S109, the electric energy storage unit 210 stores, as the updated cumulative total of the charging/discharging energy, a total value of the charging/discharging energy calculated in the time slot when n=2 and the charging/discharging energy calculated in the time slot when n=3.

The power adjustment device 200 adds 1 to n (step S110). Specifically, the power adjustment device 200 increments the number n of the time slot to be processed by one. Further, the power adjustment device 200 determines whether the number n of the time slot exceeds the number N of time slots (step S111). When n exceeds N (YES in S111), processing for all time slots in the current control period is finished, so that the process returns to S100 to perform processing in the subsequent control period. On the other hand, when n is equal to or less than N (NO in S111), the process returns to S103 to perform processing for the subsequent time slot in the current control period.

In the example embodiment, the power adjustment device 200 calculates the estimated imbalance in the current control period, and calculates the charging/discharging energy according to the estimated imbalance and the remaining time of the control period. Specifically, the proportion of the calculated charging/discharging energy in the estimated imbalance decreases when the remaining time is long. This is because when the remaining time is long, the long time can be used for adjustment of power, and thus the charging/discharging energy in each time slot can be set to be smaller than the estimated imbalance. This prevents the storage battery 142 from intensively performing charging/discharging only for a certain time interval in the control period (e.g., at the end of the control period). In other words, a difference in the charge/discharge power [W]of the storage battery 142 in each time slot can be reduced, which prevents a rapid fluctuation in the load. Therefore, the power adjustment device 200 according to the example embodiment can adjust supply and demand of power at an appropriate timing by using the storage battery 142.

Further, in the example embodiment, when the estimated imbalance exceeds the threshold Th, the power adjustment device 200 is configured to perform the charging/discharging instruction. Thus, when the estimated imbalance is small, the charging/discharging instruction is not performed. Therefore, in the example embodiment, the frequency of charge/discharge of the storage battery 142 can be suppressed. This makes it possible to prevent deterioration of the storage battery 142.

Further, the power adjustment device 200 according to the example embodiment calculates the estimated imbalance by the above-mentioned Expression (1). Specifically, in the example embodiment, the estimated imbalance is calculated as a difference between the planned value of the generated energy and the sum (consumed energy) of the cumulative total of the charging/discharging energy and the predicted value of the load consumed energy. Thus, the estimated imbalance decreases as time elapses (i.e., toward the end of the control period). Therefore, the difference between the generated energy and the consumed energy in the control period can be suppressed. Consequently, power adjustment control for achieving balancing can be performed.

Further, in the example embodiment, the estimated imbalance is calculated for each time slot, and the charging/discharging instruction is performed for each time slot. Thus, in the example embodiment, power adjustment can be performed for each time slot (for each time interval). Further, the frequency of processing can be adjusted by adjusting the time interval of each time slot. For example, since the frequency of processing is increased by reducing the time interval of each time slot, the difference between the generated energy and the consumed energy in the control period can be further suppressed. On the other hand, since the frequency of processing is suppressed by increasing the time interval of each time slot, a load on resources (including communication resources) of the power adjustment device 200 can be suppressed.

### Modification

Note that the present invention is not limited to the example embodiments described above, and can be modified as appropriate without departing from the scope of the invention. For example, the number of the power producer systems 100, the number of the power consumer systems 120, the number of the storage systems 140, and the number of the power-producer-and-supplier systems 160 are each not limited to one. One power producer system 100 may be provided with a plurality of pieces of power generation equipment 102. Similarly, one power consumer system 120 may be provided with a plurality of loads 122. Similarly, one storage system 140 may be provided with a plurality of storage battery 142. Further, the storage system 140 can be provided at any location. For example, the storage system 140 may be provided in at least one of the power producer system 100, the power consumer system 120, and the power-producer-and-supplier system 160.

Further, when the power adjustment device 200 calculates the estimated imbalance, the power adjustment device 200 refers to the planned value of the generated energy. However, the configuration of the power adjustment device is not limited to this. For example, the power adjustment device 200 may acquire the actual value of the generated energy using the electricity meter provided in the power generation equipment 102, and may calculate the estimated imbalance using the actual value of the generated energy. In this case, the generated energy in the control period may be predicted from the actual value of the generated energy in the same manner as in the prediction of the consumed energy.

In the example embodiments described above, the estimated imbalance is calculated using {(cumulative total of consumed energy of load)×N/(n−1)} in Expression (1). However, the calculation method is not limited to this, but instead any method may be employed as long as the consumed energy in the current control period can be predicted. For example, the consumed energy in each of future time slots in the current control period may be predicted from a change in the consumed energy in each of the previous time slots in the current control period, and the consumed energy in the current control period may be predicted by accumulating the predicted consumed energy. Specifically, assuming that the time slot to be currently processed is the third time slot, the consumed energy in the third and subsequent time slots may be predicted from the difference between the consumed energy in the first time slot and the consumed energy in the second time slot.

Further, in the example embodiments described above, each time slot is five minutes. However, each time slot may have any time interval as long as the time interval is shorter than the control period. Furthermore, in the example embodiments described above, a plurality of time slots have the same time interval (five minutes in the example of FIG. 5). However, the time interval is not limited to this. For example, the first time slot may be five minutes; the second time slot may be four minutes; and the third time slot may be six minutes.

Further, in the example embodiments described above, the processing illustrated in FIG. 4 is performed by causing a function as a computer included in the power adjustment device 200 to execute a program. However, the processing is not limited to this. For example, the power adjustment device 200 may incorporate a plurality of circuits for performing each processing illustrated in FIG. 4, and these circuits may perform each processing illustrated in FIG. 4. That is, the example embodiment may be implemented using a hardware configuration.

In the examples described above, the program can be stored and provided to a computer using various types of non-transitory computer readable media. Non-transitory computer readable media include various types of tangible storage media. Examples of non-transitory computer readable media include magnetic storage media (such as flexible disks, magnetic tapes, and hard disk drives), optical magnetic storage media (e.g., magneto-optical disks), CD-ROM (Read Only Memory), CD-R, CD-R/W, DVD (Digital Versatile Disc), BD (Blu-ray® Disc), and semiconductor memories (such as mask ROM, PROM (Programmable ROM), EPROM (Erasable PROM), flash ROM, RAM (Random Access Memory), etc.). The program may be provided to a computer using various types of transitory computer readable media. Examples of transitory computer readable media include electric signals, optical signals, and electromagnetic waves. Transitory computer readable media can provide the program to a computer via a wired communication line, such as an electric wire and an optical fiber, or a wireless communication line.

Further, the whole or part of the example embodiments described above can be described as, but not limited to, the following supplementary notes.

### (Supplementary Note 1)

A power adjustment device including:

difference estimation means that estimates, for each time interval shorter than a predetermined first period, a first difference between a generated energy and a consumed energy in the first period;

charging/discharging energy calculation means that calculates a charging/discharging energy based on the estimated first difference and a remaining time to an end of the first period, the charging/discharging energy being electric energy to be charged or discharged in a power storage device; and

instruction means that instructs the power storage device to charge or discharge electric energy that corresponds to the calculated charging/discharging energy.

### (Supplementary Note 2)

The power adjustment device according to Supplementary note 1, in which the instruction means performs the instructing to the power storage device when the first difference is larger than a predetermined threshold.

### (Supplementary Note 3)

The power adjustment device according to Supplementary note 1 or 2, in which the consumed energy is a total value of a load consumed energy and a cumulative value of the charging/discharging energy in the first period, at a first time in the first period, the load consumed energy being estimated to be consumed by a load of a power consumer in the first period.

### (Supplementary Note 4)

The power adjustment device according to Supplementary note 3, in which the difference estimation means estimates the load consumed energy based on an actual value of electric energy consumed by the load of the power consumer from a start time of the first period to the first time.

### (Supplementary Note 5)

The power adjustment device according to any one of Supplementary notes 1 to 4, in which the instruction means instructs, during the time interval, the power storage device to charge or discharge electric energy that corresponds to the calculated charging/discharging energy.

### (Supplementary Note 6)

A power distribution system including:

a power generation equipment;

a load;

a power adjustment device; and

a power storage device, in which

the power adjustment device includes:

difference estimation means that estimates a first difference between a generated energy generated by the power generation equipment and a consumed energy consumed by the load and the power storage device in a predetermined first period for each time interval shorter than the first period;

charging/discharging energy calculation means that calculates a charging/discharging energy based on the estimated first difference and a remaining time to an end of the first period, the charging/discharging energy being electric energy to be charged or discharged in the power storage device; and

instruction means that instructs the power storage device to charge or discharge electric energy that corresponds to the calculated charging/discharging energy.

### (Supplementary Note 7)

The power distribution system according to Supplementary note 6, in which the instruction means performs the instructing to the power storage device when the first difference is larger than a predetermined threshold.

### (Supplementary Note 8)

The power distribution system according to Supplementary note 6 or 7, in which the consumed energy is a total value of a load consumed energy and a cumulative value of the charging/discharging energy in the first period, at a first time in the first period, the load consumed energy being estimated to be consumed by the load in the first period.

### (Supplementary Note 9)

The power distribution system according to Supplementary note 8, in which the difference estimation means estimates the load consumed energy, based on an actual value of electric energy consumed by the load from a start time of the first period to the first time.

### (Supplementary Note 10)

The power distribution system according to any one of Supplementary notes 6 to 9, in which the instruction means instructs, during the time interval, the power storage device to charge or discharge electric energy that corresponds to the calculated charging/discharging energy.

### (Supplementary Note 11)

A power adjustment method including:

estimating a first difference between a generated energy and a consumed energy in a predetermined first period for each time interval shorter than the first period;

calculating a charging/discharging energy, based on the estimated first difference and a remaining time to an end of the first period, the charging/discharging energy being electric energy to be charged or discharged in a power storage device; and

instructing the power storage device to charge or discharge electric energy that corresponds to the calculated charging/discharging energy.

### (Supplementary Note 12)

The power adjustment method according to Supplementary note 11, in which the instructing includes performing an instruction to the power storage device when the first difference is larger than a predetermined threshold.

### (Supplementary Note 13)

The power adjustment method according to Supplementary note 11 or 12, in which the consumed energy is a total value of a load consumed energy and a cumulative value of the charging/discharging energy in the first period, at a first time in the first period, the load consumed energy being estimated to be consumed by a load of a power consumer in the first period.

### (Supplementary Note 14)

The power adjustment method according to Supplementary note 13, in which the load consumed energy is estimated based on an actual value of electric energy consumed by the load of the power consumer during a period from a start time of the first period to the first time.

### (Supplementary Note 15)

The power adjustment method according to any one of Supplementary notes 11 to 14, in which during the time interval, the power storage device is instructed to charge or discharge electric energy that corresponds to the calculated charging/discharging energy.

### (Supplementary Note 16)

A program for causing a computer to implement: a function for estimating a first difference between a generated energy and a consumed energy in a predetermined first period for each time interval shorter than the first period;

a function for calculating a charging/discharging energy as electric energy to be charged or discharged in a power storage device based on the estimated first difference and a remaining time to an end of the first period; and a function for instructing the power storage device to charge or discharge electric energy that corresponds to the calculated charging/discharging energy.

### (Supplementary Note 17)

The program according to Supplementary note 16, in which the function for instructing includes instructing the power storage device when the first difference is larger than a predetermined threshold.

### (Supplementary Note 18)

The program according to Supplementary note 16 or 17, in which the consumed energy is a total value of a load consumed energy and a cumulative value of the charging/discharging energy in the first period, at a first time in the first period, the load consumed energy being estimated to be consumed by a load of a power consumer in the first period.

### (Supplementary Note 19)

The program according to Supplementary note 18, in which the function for estimating the first difference includes estimating the load consumed energy based on an actual value of electric energy consumed by the load of the power consumer during a period from a start time of the first period to the first time.

### (Supplementary Note 20)

The program according to any one of Supplementary notes 16 to 19, in which the function for instructing includes instructing, during the time interval, the power storage device to charge or discharge electric energy that corresponds to the calculated charging/discharging energy.

While the present invention has been described above with reference to example embodiments, the present invention is not limited to the above example embodiments. The configuration and details of the present invention can be modified in various ways which can be understood by those skilled in the art within the scope of the invention.

This application is based upon and claims the benefit of priority from Japanese patent application No. 2014-240038, filed on Nov. 27, 2014, the disclosure of which is incorporated herein in its entirety by reference.

### REFERENCE SIGNS LIST

1 Power distribution system
10 Power adjustment device
12 Difference estimation unit
14 Charging/discharging energy calculation unit
16 Instruction unit
20 Power storage device
50 Power distribution system
100 Power producer system
102 Power generation equipment
120 Power consumer system
122 Load
124 Electricity meter
140 Storage system
142 Storage battery
144 Control device
160 Power-producer-and-supplier system
200 Power adjustment device
210 Electric energy storage unit
212 Generated energy acquisition unit
214 Consumed energy acquisition unit
216 Imbalance estimation unit
218 Estimated imbalance determination unit
220 Charging/discharging energy calculation unit
222 Charging/discharging instruction unit

1. A power adjustment device comprising circuitry configured to
estimate a first difference between a generated energy and a consumed energy in a predetermined first period for each time interval shorter than the first period;
calculate a charging/discharging energy, based on the estimated first difference and a remaining time to an end of the first period, the charging/discharging energy being electric energy to be charged or discharged in a power storage device; and
instruct the power storage device to charge or discharge electric energy corresponding to the calculated charging/discharging energy.

2. The power adjustment device according to claim 1, wherein
the circuitry configured to preform an instruction to the power storage device when the first difference is larger than a predetermined threshold.

3. The power adjustment device according to claim 1, wherein
the consumed energy is a total value of a load consumed energy and a cumulative value of the charging/discharging energy in the first period, at a first time in the first period, the load consumed energy being estimated to be consumed by a load of a power consumer in the first period.

4. The power adjustment device according to claim 3, wherein
the circuitry configured to estimate the load consumed energy, based on an actual value of electric energy consumed by the load of the power consumer from a start time of the first period to the first time.

5. The power adjustment device according to claim 1, wherein
the circuitry configured to instruct, during the time interval, the power storage device to charge or discharge electric energy corresponding to the calculated charging/discharging energy.

6. (canceled)

7. A power adjustment method comprising:
estimating a first difference between a generated energy and a consumed energy in a predetermined first period for each time interval shorter than the first period;
calculating a charging/discharging energy, based on the estimated first difference and a remaining time to an end of the first period, the charging/discharging energy being electric energy to be charged or discharged in a power storage device; and
instructing the power storage device to charge or discharge electric energy corresponding to the calculated charging/discharging energy.

8. The power adjustment method according to claim 7, wherein
the instructing comprises performing an instruction to the power storage device when the first difference is larger than a predetermined threshold.

9. The power adjustment method according to claim 7, wherein
the consumed energy is a total value of a load consumed energy and a cumulative value of the charging/discharging energy in the first period, at a first time in the first period, the load consumed energy being estimated to be consumed by a load of a power consumer in the first period.

10. A non-transitory computer-readable medium storing a program for causing a computer to implement:
a function of estimating a first difference between a generated energy and a consumed energy in a predetermined first period for each time interval shorter than the first period;
a function of calculating a charging/discharging energy as electric energy to be charged or discharged in a power storage device, based on the estimated first difference and a remaining time to an end of the first period; and
a function of instructing the power storage device to charge or discharge electric energy corresponding to the calculated charging/discharging energy.
